(19) United States
(12) Patent Application Publication
(10) Pub. No.: US 2025/0300536 A1
(43) Pub. Date: Sep. 25, 2025

(54) METHOD FOR PRODUCING A COMPONENT FOR AN ELECTRICAL MACHINE AND CORRESPONDING DEVICE FOR PRODUCING THE COMPONENT

(71) Applicant: AUDI AG, Ingolstadt (DE)

(72) Inventors: Alexander BIER, Gaimersheim (DE); Martin GERNGROß, Kinding (DE)

(73) Assignee: AUDI AG, Ingolstadt (DE)

(21) Appl. No.: 19/082,298

(22) Filed: Mar. 18, 2025

(30) Foreign Application Priority Data
Mar. 20, 2024 (DE) 102024107995.9

(51) Int. Cl. H02K 15/122

(52) U.S. Cl. CPC H02K 15/122

(57) ABSTRACT

A method for producing a component for an electrical machine, the component has a magnetic core with at least one groove which receives at least one wire winding, runs parallel to a longitudinal central axis of the component and completely penetrates the magnetic core. The component is aligned during introduction of an impregnating agent into the at least one groove in such a way that the impregnating agent is forced into the at least one groove in the direction of the longitudinal central axis by the influence of gravity. A temperature of the at least one wire winding is initially set to a lower first temperature selected to reduce a viscosity of the impregnating agent and then to a higher second temperature selected to increase the viscosity of the impregnating agent by applying an electric current during introduction of the impregnating agent into the at least one groove.

### FIELD

The invention relates to a method for producing a component for an electrical machine, wherein the component has a magnetic core with at least one groove which accommodates at least one wire winding, runs parallel to a longitudinal central axis of the component and completely penetrates the magnetic core, and wherein the component is aligned during introduction of an impregnating agent into the at least one groove such that the impregnating agent is forced into the at least one groove in the direction of the longitudinal central axis by the influence of gravity. The invention further relates to a device for producing a component for an electrical machine.

### BACKGROUND

DE 1 538 918 A, for example, is known from the prior art. This describes a method for impregnating windings of electrical machines, in which the winding is heated, whereupon impregnating agents capable of polymerization or polyaddition reaction, optionally with additives influencing the material properties, are introduced into the winding, then caused to gel and finally to harden. It is provided that a funnel which conducts the impregnating agent into the winding is placed on the vertical machine part carrying the winding, into which funnel the entire required amount of impregnating agent is poured, whereby the gelling time is set so that gelling begins as soon as the winding is completely penetrated.

Furthermore, US 2022/0094248 A1 discloses a method for manufacturing a stator of a rotating electrical machine, wherein the stator has a coil and a stator core in which a groove is formed that accommodates the coil, and wherein a filling material whose viscosity is low at a first temperature and whose viscosity is high at a second temperature higher than the first temperature is filled into the groove from an application side, the manufacturing method comprising: a first step of generating a temperature difference in the stator core so that the injection side assumes the first temperature and an opposite side of the injection side assumes the second temperature; and a second step of injecting the filling material from the injection side in a state where the temperature difference is maintained.

Furthermore, publication WO 2022/128632 A1 discloses a method for impregnating coils of a rotor with an impregnating agent, the rotor comprising a rotor shaft, a rotor core mounted on the rotor shaft, and coils arranged in channels in the rotor core, the rotor core having a first end and a second end opposite the first end, and the channels running along the rotor core from the first end to the second end, the method comprising: positioning the rotor in a vertical position such that the first end is above the second end; applying an impregnating agent to the coils from the first end while the rotor is in the vertical position such that the impregnating agent flows through the channels along the coils from the first end to the second end due to gravity; and curing the impregnating agent as it is applied to the coils only at the second end to close the second end with the cured impregnating agent while allowing the channels to fill with the impregnating agent.

### SUMMARY

It is an object of the invention to propose a method for producing a component for an electrical machine, which has advantages over known methods, in particular enables rapid and reliable filling of the groove with the impregnating agent.

This object is achieved according to the invention by a method for producing a component for an electrical machine having the features of claim 1. It is provided that a temperature of the at least one wire winding is initially set to a lower first temperature selected to reduce a viscosity of the impregnating agent and then to a higher second temperature selected to increase the viscosity of the impregnating agent by applying an electric current during the introduction of the impregnating agent into the at least one groove.

Advantageous embodiments with expedient developments of the invention are specified in the dependent claims. It is pointed out that the embodiments explained in the description are not limiting; rather, any variations of the features disclosed in the description, the claims and the figures can be implemented.

The method is used to produce the component for the electrical machine. The component is preferably part of the electrical machine, but can of course also be present separately from it, in particular until the component is mounted on or in the electrical machine. The electric machine preferably has a stator and a rotor, wherein the rotor is mounted so as to be rotatable about a rotor axis of rotation with respect to the stator. The electrical machine can basically be designed in any way, for example it can be an asynchronous machine, a permanently excited synchronous machine or a separately excited synchronous machine. Preferably, the stator or the rotor of the electrical machine forms the component, so that the component is designed as a stator or as a rotor of the electrical machine and is manufactured according to the described method. Of course, it can also be provided that both the stator and the rotor of the electrical machine are each present as such a component, i.e. both are manufactured according to the described method.

In any case, the component has a magnetic core in which at least one groove, but preferably multiple grooves, are produced. The magnetic core preferably consists of a soft magnetic material, in particular of electrical sheet or the like. As far as the description refers to at least one groove or the groove, the designs are always equivalent. Explanations which concern at least one groove also apply to the groove and vice versa. In addition, the statements can also be transferred to each of the multiple grooves, if available. The groove runs parallel to the longitudinal center axis of the component, which preferably coincides with the rotor rotation axis in the case of both the stator and the rotor, i.e. corresponds to it. The plurality of grooves are arranged spaced apart from one another in the circumferential direction, in particular they are arranged evenly distributed in the circumferential direction. Particularly preferably, the grooves each have the same distance from the longitudinal center axis.

The groove extends completely through the magnetic core in the axial direction with respect to the longitudinal central axis, so that in the axial direction it extends through opposite end faces of the magnetic core, each forming a mouth opening. The groove is limited in the circumferential direction on opposite sides by poles of the magnetic core. In the radially inward direction, the groove is limited by a groove bottom, which is also formed by the magnetic core. Preferably, the groove is open outwards in the radial direction, in particular over its entire extension in the axial direction. A radially inner region of the magnetic core, from which the poles originate, can also be referred to as the base body of the magnetic core. On their side facing away from the base body, the poles can be designed with pole shoes so that they expand in the circumferential direction on their side lying on the outside in the radial direction. The pole shoes are preferably arranged spaced apart from one another in the circumferential direction, preferably continuously in the axial direction.

At least one wire winding is arranged in the groove. For example, the wire winding surrounds one of the poles, in particular each of the poles is surrounded by such a wire winding. The at least one wire winding, i.e. the exactly one wire winding or the multiple wire windings, preferably has multiple turns, each of which surrounds the corresponding pole. If in this description the at least one wire winding or the wire winding is mentioned, the statements are always equivalent. Explanations regarding the at least one wire winding are transferable to the wire winding and statements regarding the wire winding are transferable to the at least one wire winding. If there are multiple wire windings, the explanations for the wire winding or the at least one wire winding can preferably be transferred to each of the multiple wire windings.

During the manufacture of the component, the impregnating agent is to be introduced into the groove in order to impregnate the wire winding present there. On the one hand, this serves to mechanically fix the wire winding, but on the other hand, other tasks are also fulfilled, such as increasing the electrical insulation capacity of the wire winding, improving heat dissipation from the wire winding and improving protection against environmental influences, for example against air humidity, lubricants or the like. These additional aspects are particularly important when the electric machine is used as a traction machine for a motor vehicle.

In principle, there are numerous options available for introducing the impregnating agent into the groove, in particular the trickling method, the hot dipping method and the roller dipping method. Other methods include the vacuum process (VI process), the vacuum pressure process (VPI process) and the atmospheric dipping process (dip & bake process). However, the above-mentioned methods have the disadvantage that the impregnating agent is not only introduced into the groove, but also reaches the outside of the component. This makes it necessary to carry out extensive cleaning of the component after impregnation. On the other hand, the impregnating agent can enter a coolant channel that is made in addition to the groove in the magnetic core, for example parallel to the groove. Accordingly, the impregnating agent closes and/or clogs the coolant channel, so that it has to be cleaned very laboriously. In some cases, cleaning is not even possible.

For this reason, it is intended to introduce the impregnating agent in such a way that it reaches a significant part or even exclusively the wire winding and/or the groove, but not the outside of the component. As a result, the impregnating agent is introduced into the groove in such a way that it is forced into it by the influence of gravity in the direction of the longitudinal central axis. For this purpose, the component is arranged such that its longitudinal central axis is aligned parallel or initially substantially parallel to a gravity vector. Any influence of gravity acting on the impregnating agent should therefore act exclusively or at least almost exclusively in the axial direction with respect to the longitudinal central axis.

Preferably, the impregnating agent is applied through at least one nozzle which is arranged with respect to the gravity vector above the component, in particular above the groove or one of the grooves or above a winding head formed by the wire winding. Preferably, the nozzle is arranged above the winding head, from which the wire winding extends into adjacent grooves, so that the impregnating agent flows via the winding head into both grooves. For example, multiple nozzles are used to dispense the impregnating agent, in which case each of the nozzles is arranged above one of the grooves or above multiple winding heads, so that the impregnating agent emerging from the respective nozzle is forced into the groove below the nozzle by the influence of gravity acting on the impregnating agent, for example via the winding head or an area of the wire winding arranged outside the groove.

In this case, it can be provided that the impregnating agent first hits the winding head formed by the wire winding, which is formed outside the groove of the wire winding. The impregnating agent enters the winding head, in particular between the turns of the wire winding forming the winding head, and is forced by the influence of gravity in the direction of the groove and ultimately into the groove. For example, the component has such a winding head on each of its opposite sides in the axial direction. Accordingly, after emerging from the nozzle, the impregnating agent first enters an upper winding head, then passes through the groove and exits from the groove into a lower winding head. It can then be discharged from the component therethrough. This procedure reliably avoids time-consuming cleaning of the component, since the impregnating agent mainly reaches the groove and not the outside of the component or the coolant channel.

The impregnating agent used is one which has different viscosities at different temperatures. In particular, an agent is used as the impregnating agent which has a lower first viscosity in a first temperature range and a second higher viscosity in a second temperature range. The impregnating agent is in particular an impregnating resin, such as an epoxy resin, in particular a 1K epoxy resin or a 2K epoxy resin, or a polyester resin, in particular a 1K polyester resin or a 2K polyester resin, for example a polyesterimide resin. The first temperature range is usually above an ambient temperature, so that in order to introduce the impregnating agent into the groove it is normally necessary to first temper the impregnating agent, for example to a temperature below the first temperature or below the first temperature range.

The component is preheated before the impregnating agent is added, in particular to a temperature of at least 100° C. The tempered impregnating agent is then introduced into the groove of the preheated component. Usually, however, the temperature of the impregnating agent is lower than the temperature of the component, so that heat is transferred from the component to the impregnating agent introduced into the groove. Since no heat is introduced into the component during the introduction of the impregnating agent in this procedure, but on the contrary the component cools down over time due to the heat transfer to the impregnating agent and/or due to heat loss towards the environment, the viscosity increases due to the decreasing temperature of the impregnating agent and the flowability of the impregnating agent steadily deteriorates.

If the impregnating agent is present in the groove, the component is subjected to a heat treatment, i.e. the temperature is increased, namely to a temperature in the second temperature range, so that the viscosity increases, in particular until the impregnating agent is completely solidified, for example by gelling. During this heat treatment, no further impregnating agent is usually added, so the addition is interrupted before the heat treatment. It may happen that due to the described increase in viscosity during the introduction of the impregnating agent into the groove due to the reduction of its temperature, the groove is not completely filled with the impregnating agent. Accordingly, cavities are created which are free of impregnating agent and which remain permanently in the component after the impregnating agent has solidified. This can result in poor wire winding retention, poor heat dissipation and/or component imbalance.

For this reason, it is now provided to set the wire winding to certain temperatures during the introduction of the impregnating agent into the groove, namely first to the first temperature and then to the second temperature. The second temperature is therefore not set after the impregnating agent has been added or after the addition has been completed or interrupted. Rather, the introduction preferably takes place continuously during the adjustment of the temperature, in particular during the setting of the temperature starting from the first temperature towards the second temperature or up to the second temperature. The first temperature is preferably in the first temperature range already mentioned and the second temperature is in the second temperature range also already mentioned. The first temperature of the wire winding is therefore chosen such that the viscosity of the impregnating agent is low, so that it has good flowability. For example, the first temperature of the wire winding is equal to a first temperature of the impregnating agent at which it has its lower viscosity, and the second temperature of the wire winding is equal to a second temperature of the impregnating agent at which it has its higher viscosity.

The temperature of the wire winding is adjusted by applying the electric current to the wire winding so that the wire winding is passed through by the electric current with a certain voltage and a certain current strength. This procedure has the advantage that the wire winding, between the turns of which the impregnating agent is to penetrate, is not only heated indirectly via other elements, for example via the magnetic core, but that the temperature of the wire winding is directly adjusted to a certain temperature. Accordingly, the temperature of the wire winding can be specifically adjusted using Joule's first law or the current heat law so that the impregnating agent reliably penetrates into the groove and between the turns of the wire winding. Subsequently, the temperature is adjusted—also using the Joule's law—to increase the viscosity of the impregnating agent, in particular to increase the viscosity irreversibly.

Particularly preferably, the first temperature is selected such that the viscosity of the impregnating agent is as low as possible. The first temperature is selected depending on the impregnating agent used. The second temperature is preferably selected such that the solidification of the impregnating agent takes place over a certain period of time, so that the impregnating agent has substantially the higher viscosity at the end of the period of time. The procedure described achieves a particularly effective and efficient introduction of the impregnating agent into the groove and also between the turns of the wire winding.

A further development of the invention provides that a magnetic core is used in which at least one coolant channel passes through an end face of the magnetic core and/or runs parallel to the at least one groove. The coolant channel is used to guide a coolant during operation of the electrical machine. Preferably, it is completely closed along its entire extension. The coolant channel preferably passes through the front side of the magnetic core, in particular it passes through opposite front sides of the magnetic core. By passing the coolant channel passing through the front side of the magnetic core, a mouth opening is formed, which preferably lies in the same plane as a mouth opening formed by the groove passing through the same front side.

Preferably, the coolant channel passes completely and continuously through the magnetic core in the axial direction with respect to the longitudinal center axis. In particular, it is arranged parallel to the groove. For example, the coolant channel is located further inward than the groove in the radial direction, so that a distance of the coolant channel to the longitudinal center axis is smaller than a distance of the groove to the longitudinal center axis. It can be provided that only a single coolant channel is formed in the magnetic core. Preferably, however, there are multiple coolant channels. Explanations in this description that relate to the coolant channel are transferable to the at least one coolant channel and vice versa. The embodiments are also preferably applicable to each of the multiple coolant channels, if present. The coolant channel enables particularly reliable cooling of the component during operation of the electrical machine.

A further development of the invention provides that the temperature of the at least one wire winding is adjusted by adjusting a voltage and/or a current of the electric current flowing through the at least one wire winding, in particular by controlled adjustment. The electrical resistance of the wire winding changes with its temperature, so the resistance is temperature dependent. At the same time, the resistance depends on the voltage and the current, in particular the current is a function of the voltage and the resistance and/or the voltage is a function of the current and the resistance. For example, voltage and current are adjusted in such a way that the temperature and thus the electrical resistance are kept constant, so that the overall electrical power supplied to the wire winding and the resulting amount of heat are adjusted by adjusting the current. It can be provided that the voltage is set to a target voltage and/or the current is set to a target current, in particular to a first target voltage and/or first target current selected to achieve the first temperature, and subsequently to a second target voltage and/or second target current selected to achieve the second temperature.

For example, the voltage and/or current are adjusted in a controlled manner, preferably within the context of temperature control. For this purpose, it is provided, for example, to measure the temperature of the at least one wire winding by means of a sensor or to calculate it based on the voltage and the current or on the basis of its electrical resistance. The current temperature of the wire winding, which can also be referred to as the actual temperature, is either measured or calculated, the latter by using the voltage and current. The voltage and/or the current of the current flowing through the wire winding are adjusted, in particular regulated, in such a way that the actual temperature changes in the direction of a target temperature, in particular up to this target temperature. In other words, by adjusting the voltage and/or current, the actual temperature of the wire winding is adjusted to the target temperature, wherein the target temperature temporarily corresponds to the first temperature and temporarily to the second temperature. The procedure described enables a quick and efficient adjustment of the temperature of the wire winding.

A further development of the invention provides that the impregnating agent is introduced into the at least one groove with an impregnating agent throughput which is selected depending on the temperature of the at least one wire winding, wherein in particular the impregnating agent throughput is selected to be greater at a temperature of the at least one wire winding lying in a certain temperature range than at a temperature lying outside the temperature range. It has already been explained that the viscosity of the impregnating agent depends on its temperature and therefore also indirectly on the temperature of the wire winding.

The impregnating agent is introduced into the groove with the impregnating agent throughput, i.e. an amount of impregnating agent per unit of time. The impregnating agent throughput is, for example, a mass flow or a volume flow. Since the viscosity of the impregnating agent is temperature-dependent, it is advisable to select the impregnating agent throughput depending on the temperature of the wire winding. It can be provided to determine the impregnating agent throughput during the introduction of the impregnating agent into the groove as a function of the current actual temperature of the wire winding, which is measured or calculated, for example. However, it can also be provided that the impregnating agent throughput is determined before the impregnating agent is introduced into the groove, namely by using a temperature curve which the temperature of the wire winding follows during the introduction of the impregnating agent into the groove.

It is particularly preferred that the impregnating agent throughput is selected to be greater at the temperature lying in the specific temperature range than at a temperature lying away from or outside the temperature range. The temperature range is preferably selected such that it includes the temperature at which the impregnating agent has its lowest viscosity. The temperature range is limited by a lower temperature limit towards lower temperatures and by an upper temperature limit towards higher temperatures. For example, the temperature range includes the temperature at which the lowest viscosity is achieved in the middle or this temperature limits the temperature range, especially in the direction of higher temperatures. In the former case, the temperature is halfway between the temperature limits and in the latter case it corresponds to one of the temperature limits.

If the actual temperature of the wire winding is outside the temperature range, i.e. it is greater than the upper temperature limit or less than the lower temperature limit, it is assumed that the viscosity of the impregnating agent is higher. Accordingly, the impregnating agent throughput is chosen to be smaller. Preferably, the impregnating agent throughput is chosen to be smaller the further the temperature is away or outside the temperature range. Further preferred is a procedure in which the impregnating agent throughput is selected to be smaller or reduced more strongly at temperatures above the temperature range than at temperatures below the temperature range. The procedure described ensures that the impregnating agent is introduced into the groove as required, while ensuring in particular that the impregnating agent reliably fills the groove.

A further development of the invention provides that the temperature of the at least one wire winding is increased from a starting temperature towards the first temperature and, during this time, the impregnating agent throughput is increased at least temporarily. The starting temperature is the temperature which the wire winding has at the beginning of the introduction of the impregnating agent into the groove or immediately before the introduction. For example, the starting temperature is selected such that the impregnating agent has a viscosity which is at most 50%, at most 30% or at most 10% greater than its minimum viscosity during its introduction into the groove. The starting temperature is therefore already above the ambient temperature of the device by means of which the component is manufactured.

For example, the wire winding is brought to the starting temperature by preheating, in particular also by energizing the wire winding, namely before the impregnating agent is introduced into the groove. For example, the introduction of the impregnating agent into the groove begins as soon as the temperature of the wire winding has reached the starting temperature. Starting from the starting temperature, the temperature of the wire winding is increased towards the first temperature, in particular up to the first temperature, while the impregnating agent is introduced into the groove, preferably during a first period of time. At the same time, the impregnating agent throughput is also increased. For example, the impregnating agent throughput is set to a starting throughput as soon as the temperature corresponds to the starting temperature. Starting from this initial throughput, the impregnating agent throughput is increased towards a first throughput.

It can be provided that the impregnating agent throughput already corresponds to the first impregnating agent throughput before the first temperature is reached by the temperature. However, it can also be provided that the impregnating agent throughput only reaches the first throughput as soon as the temperature corresponds to or reaches the first temperature. Preferably, both the starting temperature and the first temperature are in the already mentioned first temperature range in which a comparatively low viscosity of the impregnating agent is present. For example, the starting temperature limits the first temperature range towards lower temperatures and the first temperature towards higher temperatures. In any case, the procedure described ensures reliable introduction of the impregnating agent into the groove, in particular while avoiding voids.

A further development of the invention provides that during an increase in the temperature of the at least one wire winding from the direction of the first temperature towards the second temperature, the impregnating agent throughput is at least temporarily reduced. Preferably, the temperature is increased from the first temperature to the second temperature, in particular during a second period following the first period. At the beginning of the second period, the temperature corresponds to the first temperature and at the end of the second period, the temperature corresponds to the second temperature.

During the increase in temperature, i.e. during the second period, the impregnating agent throughput is at least temporarily reduced. For example, at the beginning of the second period it corresponds to the first throughput and at the end of the second period it corresponds to a second throughput which is lower than the first throughput. It may be provided that the impregnating agent throughput already corresponds to the second throughput before the end of the second period and is maintained at this level until the end of the second period.

For example, the impregnating agent throughput reaches the second throughput after a lapse of at least 20%, at least 40% or at least 60% and/or at most 90%, at most 80% or at most 70% of the second period. By increasing the temperature towards the second temperature, the viscosity of the impregnating agent increases, in particular gelling of the impregnating agent begins. Since impregnating agent continues to be introduced into the groove also during the second period, reliable filling of the groove with the impregnating agent is ensured and the formation of cavities is avoided.

A further development of the invention provides that the temperature of the at least one wire winding is adapted from the second temperature towards a final temperature and, during this time, the impregnating agent throughput is reduced at least temporarily. The final temperature is the temperature which the wire winding has at the end of the introduction of the impregnating agent into the groove, i.e. when the supply of impregnating agent into the groove is terminated. It may be provided that the final temperature corresponds to the second temperature. Alternatively, it is greater than the second temperature.

The adjustment of the temperature from the second temperature towards the final temperature takes place during a third period. At the beginning of the third period, the temperature corresponds to the second temperature, and at the end of the third period, the temperature corresponds to the final temperature. Preferably, the introduction of the impregnating agent into the groove is stopped at the end of the third period, i.e. the impregnating agent throughput is reduced to zero. Preferably, the impregnating agent throughput at the beginning of the third period corresponds to the second throughput or a further second throughput which is lower than the second throughput. It may therefore be provided to reduce the impregnating agent throughput at the end of the second period or at the beginning of the third period, in particular suddenly.

During the third period, the impregnating agent throughput is at least temporarily reduced, in particular starting from the second throughput or the further second throughput towards a third throughput. This takes into account the fact that the impregnating agent is solidified during the third period, in particular by gelling. However, impregnating agent is still introduced into the groove to ensure that the groove is completely filled. This procedure enables a particularly high degree of filling of the groove with the impregnating agent to be achieved.

A further development of the invention provides that after reaching the final temperature, the temperature of the at least one wire winding is kept constant over a certain period of time, in particular over a period of time selected depending on the final temperature. The period can also be called the fourth period. During the fourth period, the impregnating agent undergoes complete solidification; in particular, the length of the period is chosen such that the impregnating agent is completely solidified or gelled. During the period, the temperature of the wire winding is kept constant, especially at the final temperature. The period or its length is preferably chosen depending on the final temperature, since the speed at which the impregnating agent is solidified is temperature-dependent. The higher the temperature, the shorter the period chosen and vice versa. By selecting the time period according to requirements, the shortest possible cycle time is achieved when manufacturing the component.

A further development of the invention provides that the temperature of the at least one wire winding is set according to a predetermined temperature curve and the impregnating agent throughput is set according to a predetermined throughput curve, wherein the temperature curve and the throughput curve are determined depending on the impregnating agent and/or a geometry of the component. The temperature curve is a curve of the temperature over time and the throughput curve is a curve of the impregnating agent throughput over time.

Both the temperature curve and the throughput curve are determined before the impregnating agent is introduced into the groove and are subsequently run as a function of time. During the introduction of the impregnating agent into the groove, the temperature of the wire winding is adjusted according to the temperature curve and the impregnating agent throughput is adjusted according to the throughput curve. In order to match the component and the impregnating agent, the temperature curve and the throughput curve are determined and specified depending on the impregnating agent and/or the component or its geometry. The use of the curves enables a particularly short cycle time in the production of the component, while at the same time achieving the advantages already mentioned.

A further development of the invention provides that a total amount of the impregnating agent in the at least one groove is determined on the basis of an inlet quantity of the impregnating agent entering the at least one groove and an outlet quantity of the impregnating agent exiting the at least one groove, and the temperature and/or the impregnating agent throughput are selected as a function of the total amount. On the one hand, the inlet quantity is determined, in particular from the amount of impregnating agent which is introduced into the groove per unit of time. For example, the inlet quantity corresponds to the quantity of impregnating agent which is discharged from the at least one nozzle.

In addition, the outlet quantity is detected, preferably from the amount of impregnating agent which exits the groove per unit of time. The difference between the inlet quantity and the outlet quantity can be used to determine the amount of impregnating agent remaining in the groove. For example, it is intended to increase the temperature starting from the first temperature towards the second temperature as soon as the total amount of the impregnating agent exceeds a threshold value, i.e. is greater than this. This ensures that the impregnating agent only solidifies when the groove is completely or at least almost completely filled with the impregnating agent. In addition, it may be provided that the impregnating agent throughput is chosen to be lower the closer the total quantity is to the threshold value in order to reduce consumption of the impregnating agent. With the procedure described, the advantages already mentioned are realized.

A further development of the invention provides that after the impregnating agent has been introduced into the at least one groove, the temperature of the at least one wire winding is adjusted by means of an external heating device. This occurs in particular during the fourth period already mentioned, in which the impregnating agent solidifies. It may be provided that the external heating device is used in addition to the application of the electric current to the wire winding for adjusting the temperature.

However, it is particularly preferred to stop the application of the electric current to the wire winding and to maintain the temperature of the wire winding using the external heating device. This is done in particular in such a way that the impregnating agent hardens completely. An oven, for example, is used as an external heating device in which the component is placed. Preferably, the orientation of the longitudinal center axis of the component is maintained so that the longitudinal center axis is aligned identically during heating of the component using the external heating device as during introduction of the impregnating agent. This in turn ensures that the impregnating agent hardens evenly.

Additionally or alternatively, the external heating device or another external heating device is also used to preheat the component. During preheating, the temperature of the component is increased before the impregnating agent is introduced into the groove. For example, the component is preheated to the first temperature during preheating, so that the subsequent energy requirement for adjusting its temperature to the first temperature by energizing the wire winding is lower.

A further development of the invention provides that the impregnating agent for introduction into the at least one groove is applied through at least one nozzle, which is at least temporarily displaced relative to the component. The use of the nozzle for dispensing the impregnating agent or for introducing it into the groove has already been mentioned. The nozzle is temporarily displaced relative to the component, especially during the introduction of the impregnating agent into the groove. For example, the nozzle is moved above the groove according to a movement path, which is, for example, circular. The nozzle is moved in such a way that the impregnating agent is evenly distributed in the groove or is introduced in such a way that the impregnating agent is evenly distributed in the groove.

The invention also relates to a device for producing a component for an electrical machine, in particular for performing the method according the description, wherein the component has a magnetic core with at least one groove which accommodates at least one wire winding, runs parallel to a longitudinal central axis of the component and completely penetrates the magnetic core, and wherein the device is provided and designed so that the component is aligned during introduction of an impregnating agent into the at least one groove such that the impregnating agent is forced into the at least one groove in the direction of the longitudinal central axis by the influence of gravity.

The device is also provided and designed in such a way that a temperature of the at least one wire winding is initially set to a lower first temperature selected to reduce a viscosity of the impregnating agent and then to a higher second temperature selected to increase the viscosity of the impregnating agent by applying an electric current during the introduction of the impregnating agent into the at least one groove.

The advantages of such an embodiment of the device for producing a component for an electric machine or such a procedure have already been discussed. Both the device and also the method for its operation can be refined according to the statements within the scope of this description, to which reference will therefore be made.

The features and feature combinations described in the description, in particular the features and feature combinations described below in the description of the figures and/or shown in the figures may be used not only in the respective specified combination, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURES

In the following, the invention will be explained in greater detail with reference to the exemplary embodiments depicted in the drawings, without this restricting the invention. In particular:

FIG. 1 is a schematic representation of a device for producing a component for an electrical machine and of the component,

FIG. 2 is a schematic cross-sectional view of the component for the electrical machine, and

FIG. 3 shows two diagrams in which a temperature curve and an impregnating agent throughput are each plotted over time as examples.

### DETAILED DESCRIPTION

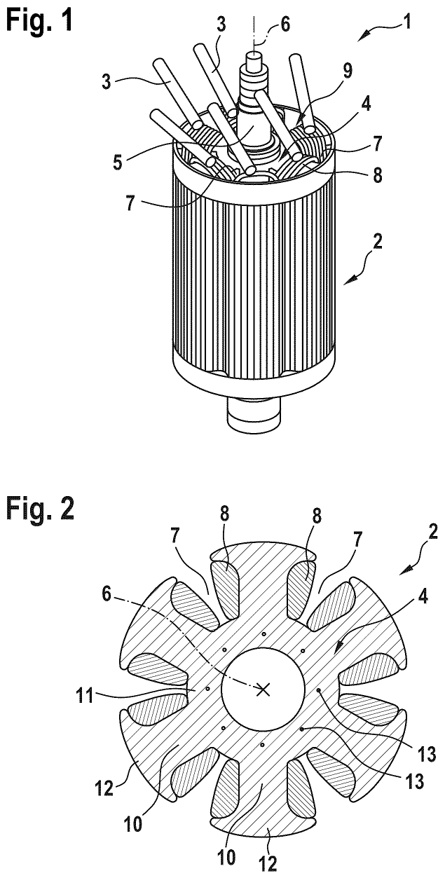

FIG. 1 shows schematically a device 1 for producing a component 2 for an electrical machine not shown in detail. Of the device, only at least one nozzle 3 (here: multiple nozzles 3) is shown, by means of which an impregnating agent can be applied in the direction of the component 2. Component 2 is purely an example of the rotor of the electric machine. It has a magnetic core 4, which is arranged on a shaft 5 of the electric machine and is mounted together with the latter so as to be rotatable about an axis of rotation 6.

Multiple grooves 7 are made in the magnetic core 4, of which only a few are shown here as examples. At least one wire winding 8 is received in the grooves 7. An embodiment is shown in which there are multiple grooves 7 in which multiple wire windings 8 are arranged. The wire windings 8 form a winding head 9 on the front side of the magnetic core 4 so that they protrude beyond the magnetic core 4 in the axial direction with respect to the axis of rotation 6. Preferably, displacement bodies (not shown here) are also arranged in the grooves 7. The displacement bodies serve to space wire windings 8 arranged in the same groove 7 in the circumferential direction. The displacement bodies serve to reliably hold the wire windings 8 in the circumferential direction. They are preferably made of a non-magnetic and/or non-magnetizable material, for example plastic.

By means of at least one nozzle 3, the impregnating agent is introduced into the grooves 7 of the magnetic core 4. For this purpose, the component 2 is aligned vertically, i.e. in such a way that its longitudinal center axis, which here coincides with the axis of rotation 6, is aligned vertically. This means that the longitudinal central axis runs parallel to a gravity vector or is perpendicular to an imaginary plane, which in turn is perpendicular to the gravity vector.

FIG. 2 shows a schematic cross-sectional view of the component 2. The magnetic core 4 can be seen, which has multiple poles 10 that extend outwards in the radial direction with respect to the axis of rotation 6 from a base body 11. The poles 10 each have a pole shoe 12 on their radially outer side, in the area of which they widen in the circumferential direction. Both the poles 10 and the pole shoes 12 are arranged at a distance from each other in the circumferential direction and therefore do not touch each other. In particular, the displacement bodies already mentioned engage between the poles 10, preferably also between the pole shoes 12. The displacement bodies are arranged in the circumferential direction between adjacent poles 10 and/or adjacent pole shoes 12. In particular, the displacement bodies rest on the pole shoes 12 on opposite sides in the circumferential direction.

The poles 10 circumferentially delimit the grooves 7 in which the wire windings 8 are arranged. In particular, each of the poles 10 is assigned such a wire winding 8 or each of the poles 10 is surrounded by such a wire winding, so that each of the wire windings 8 is present in grooves 7 delimited by the same pole 10. It can be seen that in the magnetic core 4, in particular in the base body 11, multiple additional coolant channels 13 are produced, of which only some are indicated by way of example.

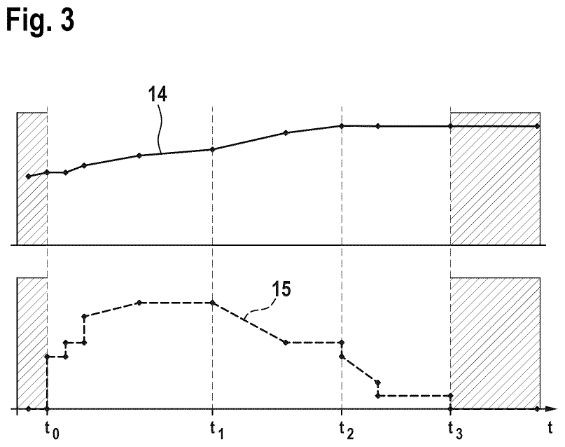

FIG. 3 shows two diagrams in which a temperature and an impregnating agent throughput are plotted against time, namely the temperature in a curve 14 and the impregnating agent throughput in a curve 15. multiple points in time t₀, t₁, t₂, and t₃ are indicated, with a first period for t₀≤t<t₁, a second period for t₁≤t<t₂, and a third period for t₂≤t<t₃. A fourth period occurs for t≥ t₃. The temperature shown by the curve 14 is an actual temperature of the wire winding 8, which is set by energizing the wire winding 8. For example, it is provided to measure or calculate the actual temperature of the wire winding 8 and to adjust a current intensity and/or a voltage of the electrical current supplied to the wire winding 8 such that the actual temperature of the wire winding 8 is adjusted to a target temperature.

The impregnating agent throughput of the curve 15 describes the throughput with which the impregnating agent is introduced into the grooves 7 of the magnetic core 4. At the beginning of the first period, i.e. at time to, the temperature corresponds to an initial temperature and the impregnating agent throughput corresponds to an initial throughput. During the first period, the temperature is increased towards a first temperature. In addition, the throughput is increased towards a first throughput. During the second period, the temperature is further increased from the first temperature toward a second temperature, whereas the throughput is decreased from the first throughput toward a second throughput.

In the third period, the temperature is adjusted starting from the second temperature towards a final temperature, wherein the final temperature in the illustrated embodiment corresponds to the second temperature. During the third period, the throughput is also reduced starting from the second throughput, namely towards a final throughput which is, for example, equal to zero. In the fourth period, the temperature of the wire winding 8 is kept at the final temperature, but no more impregnating agent is introduced into the grooves 7.

During the first period, the temperature of the wire winding 8 is selected such that the viscosity of the impregnating agent is as low as possible. During the second period, the temperature of the wire winding 7 is increased, namely such that a temperature is reached at which solidification of the impregnating agent begins, in particular gelling of the impregnating agent. This temperature is maintained during the third period to ensure continuous solidification of the impregnating agent. During the fourth period, the temperature of the wire winding 8 is maintained, for example by means of an external heating device, until the impregnating agent has completely cured.

Using the described procedure for producing the component 2 for the electrical machine, a high degree of filling of the grooves 7 with the impregnating agent is achieved by combining different measures. On the one hand, the longitudinal center axis of the component 2 is aligned vertically, so that the impregnating agent is forced or conveyed through the grooves 7 in the axial direction with respect to the longitudinal center axis by the influence of gravity, in particular by the influence of gravity alone. On the other hand, the desired temperature is achieved in a simple manner by energizing the wire windings 8. The temperature of the wire winding 8 and the impregnating agent throughput are also selected such that firstly complete penetration of the impregnating agent into the grooves 7 is ensured and then solidification of the impregnating agent is achieved while simultaneously holding the impregnating agent in the groove 7.

### LIST OF REFERENCE NUMERALS

1 device
2 component
3 nozzle
4 magnetic core
5 shaft
6 axis of rotation
7 groove
8 wire winding
9 winding head
10 pole
11 base body
12 pole shoe
13 coolant channel
14 curve
15 curve

1. A method for producing a component for an electrical machine, wherein the component has a magnetic core with at least one groove which receives at least one wire winding, runs parallel to a longitudinal central axis of the component and completely penetrates the magnetic core, and wherein the component is aligned during introduction of an impregnating agent into the at least one groove in such a way that the impregnating agent is forced into the at least one groove in the direction of the longitudinal central axis by the influence of gravity, wherein a temperature of the at least one wire winding is initially set to a lower first temperature selected to reduce a viscosity of the impregnating agent and then to a higher second temperature selected to increase the viscosity of the impregnating agent by applying an electric current during introduction of the impregnating agent into the at least one groove.

2. The method according to claim 1, wherein the adjustment of the temperature of the at least one wire winding is carried out by adjusting a voltage and/or a current intensity of the electric current flowing through the at least one wire winding.

3. The method according to claim 1, wherein the impregnating agent is introduced into the at least one groove with an impregnating agent throughput which is selected as a function of the temperature of the at least one wire winding.

4. The method according to claim 1, wherein the temperature of the at least one wire winding is increased from a starting temperature towards the first temperature and during this time the impregnating agent throughput is increased at least temporarily.

5. The method according to claim 1, wherein during an increase in the temperature of the at least one wire winding from the direction of the first temperature towards the second temperature, the impregnating agent throughput is at least temporarily reduced.

6. The method according to claim 1, wherein the temperature of the at least one wire winding is adapted from a starting temperature towards a final temperature and during this time the impregnating agent throughput is reduced at least temporarily.

7. The method according to claim 1, wherein after reaching the final temperature, the temperature of the at least one wire winding is kept constant over a certain period of time.

8. The method according to claim 1, wherein the temperature of the at least one wire winding is set according to a predetermined temperature curve and the impregnating agent throughput is set according to a predetermined throughput curve, wherein the temperature curve and the throughput curve are determined depending on the impregnating agent and/or a geometry of the component.

9. The method according to claim 1, wherein the impregnating agent for introduction into the at least one groove is applied through at least one nozzle which is at least temporarily displaced relative to the component.

10. A device for producing a component for an electrical machine, wherein the component has a magnetic core with at least one groove which receives at least one wire winding, runs parallel to a longitudinal central axis of the component and completely penetrates the magnetic core, and wherein the device is provided and designed so that the component is aligned during introduction of an impregnating agent into the at least one groove in such a way that the impregnating agent is forced into the at least one groove in the direction of the longitudinal central axis by the influence of gravity, wherein the device is further provided and designed such that a temperature of the at least one wire winding is initially set to a lower first temperature selected to reduce a viscosity of the impregnating agent and then to a higher second temperature selected to increase the viscosity of the impregnating agent by applying an electric current during introduction of the impregnating agent into the at least one groove.

11. The method according to claim 2, wherein the impregnating agent is introduced into the at least one groove with an impregnating agent throughput which is selected as a function of the temperature of the at least one wire winding.

12. The method according to claim 2, wherein the temperature of the at least one wire winding is increased from a starting temperature towards the first temperature and during this time the impregnating agent throughput is increased at least temporarily.

13. The method according to claim 3, wherein the temperature of the at least one wire winding is increased from a starting temperature towards the first temperature and during this time the impregnating agent throughput is increased at least temporarily.

14. The method according to claim 2, wherein during an increase in the temperature of the at least one wire winding from the direction of the first temperature towards the second temperature, the impregnating agent throughput is at least temporarily reduced.

15. The method according to claim 3, wherein during an increase in the temperature of the at least one wire winding from the direction of the first temperature towards the second temperature, the impregnating agent throughput is at least temporarily reduced.

16. The method according to claim 4, wherein during an increase in the temperature of the at least one wire winding from the direction of the first temperature towards the second temperature, the impregnating agent throughput is at least temporarily reduced.

17. The method according to claim 2, wherein the temperature of the at least one wire winding is adapted from a starting temperature towards a final temperature and during this time the impregnating agent throughput is reduced at least temporarily.

18. The method according to claim 3, wherein the temperature of the at least one wire winding is adapted from a starting temperature towards a final temperature and during this time the impregnating agent throughput is reduced at least temporarily.

19. The method according to claim 4, wherein the temperature of the at least one wire winding is adapted from a starting temperature towards a final temperature and during this time the impregnating agent throughput is reduced at least temporarily.

20. The method according to claim 5, wherein the temperature of the at least one wire winding is adapted from a starting temperature towards a final temperature and during this time the impregnating agent throughput is reduced at least temporarily.
